(19) United States
(12) Patent Application Publication
(10) Pub. No.: US 2026/0286156 A1
(43) Pub. Date: Sep. 24, 2026

(54) INK COMPOSITION, APPLYING SYSTEM FOR INK COMPOSITION, AND APPLYING METHOD FOR INK COMPOSITION

(71) Applicant: MIMAKI ENGINEERING CO., LTD., Nagano (JP)

(72) Inventors: Ryo Nishizawa, Nagano (JP); Keisuke Okino, Nagano (JP); Kazuki OHARA, Nagano (JP)

(73) Assignee: MIMAKI ENGINEERING CO., LTD., Nagano (JP)

(21) Appl. No.: 19/570,145

(22) Filed: Mar. 17, 2026

(30) Foreign Application Priority Data
Mar. 19, 2025 (JP) 2025-046108
Feb. 6, 2026 (JP) 2026-018343

(51) Int. Cl. C09D 11/30; B41J 11/00; B41M 7/00

(52) U.S. Cl. CPC C09D 11/30; B41J 11/00214; B41M 7/0081

(57) ABSTRACT

Provided is a photocurable ink composition which includes a decorative component and suppresses yellowness after curing. The ink composition includes a photopolymerizable compound and a photopolymerization initiator. The photopolymerization initiator has a predetermined light absorption spectrum in a wavelength region of 360 nm or more and less than 410 nm, and is contained in an amount of 1% by weight or more and less than 15% by weight relative to the total weight of the ink composition.

### CROSS-REFERENCE TO RELATED APPLICATION

This application claims the priority benefit of Japanese application serial no. 2025-046108, filed on Mar. 19, 2025, and Japanese application serial no. 2026-018343, filed on Feb. 6, 2026. The entirety of the above-mentioned patent application is hereby incorporated by reference herein and made a part of this specification.

### TECHNICAL FIELD

The disclosure relates to an ink composition, an applying system for ink composition, and an applying method for ink composition.

### BACKGROUND ART

Patent Document 1 (Japanese Patent Application Laid-Open No. 2011-246718) discloses a dispersion used as the raw material for metallic pigment ink, in which flaky thin film fine powder is dispersed.

Here, this type of dispersion also includes ink compositions containing photopolymerizable compounds.

Ink compositions containing photopolymerizable compounds include photopolymerization initiators that absorb irradiated light to generate radicals (active species) and participate in polymerization of the photopolymerizable compounds. The light absorption spectrum of photopolymerization initiators varies depending on the wavelength of the irradiated light source, but photopolymerization initiators having a light absorption spectrum of 360 nm to 410 nm, which is the wavelength of commonly used LEDs, are often yellowish. Therefore, if ink compositions contain photopolymerization initiators, unused photopolymerization initiators may remain in the printed matter even after curing, and the yellowness of the printed matter may become strong depending on the types of photopolymerization initiators. It is required for ink compositions to be able to suppress yellowness after curing.

It is noted that in addition to such requirements, another objective of the disclosure is to achieve actions and effects derived from the various configurations disclosed in the “DESCRIPTION OF THE EMBODIMENTS” described later, which actions and effects cannot be obtained with conventional techniques.

As a result of intensive investigation, the inventors of the disclosure found that when using photopolymerization initiators having a peak (absorption peak) in a wavelength region of 410 nm or more, there is a tendency for yellowness after curing to become strong. The inventors then confirmed that yellowness after curing can be suppressed by using photopolymerization initiators having a predetermined light absorption spectrum on the lower wavelength side than 410 nm.

### SUMMARY

Specifically, according to one aspect of the disclosure,
(1) an ink composition includes: a photopolymerizable compound and a photopolymerization initiator, in which:
the photopolymerization initiator has a predetermined light absorption spectrum in a wavelength region of 360 nm or more and less than 410 nm, and is contained in an amount of 1% by weight or more and less than 15% by weight relative to a total weight of the ink composition.

When the photopolymerization initiator having a predetermined light absorption spectrum on the lower wavelength side than 410 nm, specifically in a wavelength region of 360 nm or more and less than 410 nm, is contained in an amount of 1% by weight or more and less than 15% by weight relative to the total weight of the ink composition, yellowness after curing can be suppressed.

According to one aspect of the disclosure,
(2) in the ink composition, the photopolymerization initiator has a light absorption spectrum that has a peak in a wavelength region of less than 400 nm, and has absorbance that decreases and converges to zero in a wavelength region of 400 nm or more.

When the photopolymerization initiator that has most of the peak in a wavelength region of less than 400 nm is used, yellowness after curing can be suppressed. Furthermore, since the photopolymerization initiator has a light absorption spectrum in which absorbance decreases and converges to zero in a wavelength region of 400 nm or more, even with a peak in a wavelength region of less than 400 nm, light can be absorbed by increasing integrated light dose to generate active species (radicals) and initiate the photocuring reaction of the photopolymerizable compound.

Therefore, yellowness after curing can be suppressed while appropriately curing the photopolymerizable compound.

According to one aspect of the disclosure,
(3) in the ink composition, the photopolymerizable compound includes at least one of a multifunctional monomer and a multifunctional oligomer, and at least one of the multifunctional monomer and the multifunctional oligomer is contained in an amount of 20% by weight or more and less than 40% by weight relative to the total weight of the ink composition.

Multifunctional monomers and oligomers have a plurality of functional groups such as acrylate groups and epoxy groups within the molecule. That is, multifunctional monomers and oligomers include a plurality of reaction sites within the molecule, and form many crosslinking points between molecules to form a strong cured film in response to light irradiation. This makes it possible to suppress yellowness while ensuring the strength of the film after curing.

According to one aspect of the disclosure,
(4) in the ink composition, the photopolymerizable compound further includes a monofunctional monomer in an amount of 20% by weight or more and less than 55% by weight relative to the total weight of the ink composition.

Monofunctional monomers have low viscosity, and by mixing with multifunctional monomers and multifunctional oligomers, the viscosity of the ink composition can be adjusted. This makes it possible to enhance the fluidity of the ink composition before curing and improve leveling properties during printing. Furthermore, by adjusting the amount of monofunctional monomers, it becomes possible to accommodate discharge from various mechanisms ranging from inkjet to dispenser.

This makes adjustment possible in portions where the applied ink compositions overlap, so that the ink compositions blend together and boundaries become indistinct in the short time before light irradiation.

In the case of the ink composition having low leveling properties, stripe patterns may remain along the boundaries between ink compositions in portions where the ink compositions overlap. In this state, stripe patterns may occur after curing in response to light irradiation.

As described above, by adjusting the amount of monofunctional monomers, the leveling properties of the ink composition can be improved and the occurrence of stripe patterns can be suitably prevented.

According to one aspect of the disclosure,
(5) in the ink composition, the photopolymerization initiator has a peak at least at any one of 365 nm, 385 nm, and 405 nm, and is capable of releasing active species.

With this configuration, the ink composition including the photopolymerizable compound can be cured using a UV-LED light source that has a single peak (peak wavelength). UV-LED light sources are less expensive, generate less heat, and have higher light utilization efficiency compared to high pressure mercury lamps and metal halide lamps. Therefore, the disclosure can also suitably deal with cases where the photopolymerizable compound is cured with a UV-LED light source.

According to one aspect of the disclosure,
(6) an applying system for ink composition includes: an applying apparatus that applies to a workpiece an ink composition including at least a photopolymerizable compound and a photopolymerization initiator; and a light irradiation apparatus that irradiates light to the workpiece applied with the ink composition, in which:
the photopolymerizable compound includes at least one of a multifunctional monomer and a multifunctional oligomer, and a monofunctional monomer,
at least one of the multifunctional monomer and the multifunctional oligomer is contained in an amount of 20% by weight or more and less than 40% by weight relative to a total weight of the ink composition,
the monofunctional monomer is contained in an amount of 20% by weight or more and less than 55% by weight relative to the total weight of the ink composition,
the photopolymerization initiator has a predetermined light absorption spectrum in a wavelength region of 360 nm or more and less than 410 nm, and is contained in an amount of 1% by weight or more and less than 15% by weight relative to the total weight of the ink composition, and
the light irradiation apparatus includes at least one of a high pressure mercury lamp, a metal halide lamp, and a UV-LED as a light source.

With this configuration, the ink composition including the photopolymerizable compound can be cured using a UV-LED light source having a single wavelength peak. UV-LED light sources are less expensive, generate less heat, and have higher light utilization efficiency compared to high pressure mercury lamps and metal halide lamps. Therefore, the disclosure can suitably deal with cases where the photopolymerizable compound is cured with a UV-LED light source.

According to one aspect of the disclosure,
(7) in the applying system for ink composition, in a case where the UV-LED is used as the light source, an irradiation dose of the light is set so that an integrated light dose of light irradiated to the workpiece applied with the ink composition becomes at least 2,000 mJ/cm² or more and less than 10,000 mJ/cm².

With this configuration, by increasing the integrated light dose, the ink composition including the photopolymerizable compound can be cured using a UV-LED light source having a single wavelength peak.

According to one aspect of the disclosure,
(8) an applying method for ink composition is provided for applying to a workpiece an ink composition including at least a photopolymerizable compound and a photopolymerization initiator, and
the applying method for ink composition includes:
applying to the workpiece the ink composition; and
irradiating light to the workpiece applied with the ink composition to cure the photopolymerizable compound, in which:
the photopolymerizable compound includes at least one of a multifunctional monomer and a multifunctional oligomer, and a monofunctional monomer,
at least one of the multifunctional monomer and the multifunctional oligomer is contained in an amount of 20% by weight or more and less than 40% by weight relative to a total weight of the ink composition,
the monofunctional monomer is contained in an amount of 20% by weight or more and less than 55% by weight relative to the total weight of the ink composition,
the photopolymerization initiator has a predetermined light absorption spectrum in a wavelength region of 360 nm or more and less than 410 nm, and is contained in an amount of 1% by weight or more and less than 15% by weight relative to the total weight of the ink composition,
the ink composition is applied on the workpiece by any one of spray applying, coater applying, and inkjet applying, and
light is irradiated to the workpiece applied with the ink composition from any light source of a high pressure mercury lamp, a metal halide lamp, and a UV-LED.

With this configuration, the ink composition including the photopolymerizable compound can be cured using a UV-LED light source having a single wavelength peak. UV-LED light sources are less expensive, generate less heat, and have higher light utilization efficiency compared to high pressure mercury lamps and metal halide lamps. Therefore, the disclosure can suitably deal with cases where the photopolymerizable compound is cured with a UV-LED light source.

According to one aspect of the disclosure,
(9) in the applying method, in a case of irradiating light from the UV-LED, an irradiation dose of the light is set so that an integrated light dose of light irradiated to the workpiece applied with the ink composition becomes at least 2,000 mJ/cm² or more and less than 10,000 mJ/cm².

With this configuration, the ink composition including the photopolymerizable compound can be cured using a UV-LED light source having a single wavelength peak.

According to the disclosure, it is possible to suppress yellowness after curing in a photocurable ink composition.

### BRIEF DESCRIPTION OF THE DRAWINGS

FIG. 1 is a light absorption spectrum of photopolymerization initiator A.

FIG. 2 is a light absorption spectrum of photopolymerization initiator B.

FIG. 3 is a light absorption spectrum of photopolymerization initiator C.

FIG. 4 is a light absorption spectrum of photopolymerization initiator D.

FIG. 5 is a light absorption spectrum of photopolymerization initiator E.

FIG. 6 is a light absorption spectrum of photopolymerization initiator F.

FIG. 7 is a light absorption spectrum of photopolymerization initiator G.

FIG. 8 is a light absorption spectrum of photopolymerization initiator H.

FIG. 9 is a schematic diagram illustrating the schematic configuration of the applying system.

FIG. 10 is a flowchart illustrating the process from applying the ink composition on a workpiece to curing.

FIG. 11A to FIG. 11D are schematic diagrams illustrating the snowman test.

FIG. 12A and FIG. 12B are schematic diagrams illustrating the evaluation of applying streaks.

### DESCRIPTION OF THE EMBODIMENTS

Hereinafter, an ink composition including a photocurable compound, an applying system and an applying method using this ink composition will be described as embodiments of the disclosure.

[Ink Composition]

The ink composition includes a photopolymerizable compound, a monofunctional monomer, and a photopolymerization initiator. The ink composition used in the present embodiment may include coloring components such as pigments and dyes, and may also include additives having functionality such as phosphorescence, glitter, and pearl. In the case of including coloring components, it is preferable that the coloring components are not dark coloring components.

It is noted that in the case of emphasizing the decorative effect brought by additives having functionality (decorative components), a clear ink composition that does not include coloring components may be used. In the case of a clear ink composition, it is used, for example, as an applying agent that covers the surface of printed matter on which information such as patterns and characters are printed.

### [Decorative Component]

The “additives having functionality” in this specification are materials added to a transparent ink composition to impart a decorative effect to printed matter. The following are exemplified as decorative components: (a) powdered metallic pigments obtained by finely pulverizing metals or metal compounds, (b) polarizing pigments obtained by applying to the surface of silica gel titanium oxide or the like, (c) pearl pigments, and (d) aluminum.

Decorative components often have particle sizes larger than the particle sizes of pigments contained in conventionally known ink compositions for inkjet printing. Further, since decorative components have larger specific gravity than pigments or the like, decorative components tend to settle easily in the case of ink compositions having low viscosity.

### [Photopolymerizable Compound]

The photopolymerizable compound may include at least one of a multifunctional monomer and a multifunctional oligomer.

Multifunctional monomers and multifunctional oligomers have a plurality of functional groups such as acrylate groups (acryloyl groups) and epoxy groups within the molecule. That is, multifunctional monomers and oligomers include a plurality of reaction sites within the molecule, and form many crosslinking points between molecules to form a strong cured film in response to light irradiation. However, in the case of a large amount of multifunctional monomers being contained, the degree of curing shrinkage becomes large, which may cause film performance to deteriorate.

As the multifunctional monomer used in the present embodiment, a bifunctional monomer having two acrylate groups or the like serving as reaction sites is preferable.

Examples of this type of multifunctional monomer include bifunctional monomers such as dipropylene glycol diacrylate, tricyclodecane dimethanol diacrylate, 1,6-hexanediol diacrylate, tripropylene glycol diacrylate, 2-ethylhexyl acrylate, and lauryl acrylate, and trifunctional monomers such as trimethylolpropane triacrylate and trimethylolpropane ethoxy triacrylate.

As the multifunctional oligomer used in the present embodiment, a urethane acrylate-based bifunctional oligomer and a urethane acrylate-based trifunctional oligomer are preferable.

A urethane acrylate-based bifunctional oligomer has acrylate groups serving as reaction sites at two terminals. A urethane acrylate-based trifunctional oligomer has acrylate groups serving as reaction sites at three terminals.

Examples of this type of multifunctional oligomer include trifunctional aliphatic urethane acrylate oligomers such as Photomer 6008, Photomer 6010, Photomer 6019, Photomer 6184 (product names: manufactured by BASF), CN929, CN971, CN972, CN989 (product names: manufactured by Sartomer), MIRAMER PU320, PU330, PU340 (product names: manufactured by Miwon Specialty Chemical), and EBECRYL 264, EBECRYL 265, EBECRYL 294, EBECRYL 295 HD (product names: manufactured by Daicel Allnex), bifunctional aliphatic urethane acrylate oligomers such as MIRAMER PU2100, PU2200, PU2510, PU2560 (product names: manufactured by Miwon Specialty Chemical), CN962, CN963, CN964, CN965, CN975, CN978, CN980, CN9001, CN9002 (product names: manufactured by Sartomer), Photomer 6210, Photomer 6230, Photomer 6891, Photomer 6892 (product names: manufactured by BASF), and EBECRYL 230, EBECRYL 270, EBECRYL 4858, EBECRYL 8402, EBECRYL 8804, EBECRYL 8807, EBECRYL 9270 (product names: manufactured by Daicel Allnex), and the like.

The photopolymerizable compound may be used by optionally combining two or more types of multifunctional monomers and two or more types of multifunctional oligomers.

In the present embodiment, the photopolymerizable compound is contained in an amount of 20% by weight or more and less than 40% by weight relative to the total weight of the ink composition.

### [Monofunctional Monomer]

The monofunctional monomer is a monomer having one functional group serving as a reaction site, and is used for adjusting the viscosity and Tg (glass transition temperature) of the ink composition. The monofunctional monomer is preferably a molecule having one unsaturated bond (for example, a double bond) and is an acrylate-based or methacrylate-based monomer.

Examples of the monofunctional monomer used in the present embodiment include phenoxyethyl (meth)acrylate, phenoxyethyl acrylate, isobornyl acrylate, tetrahydrofurfuryl (meth)acrylate, isobornyl (meth)acrylate, 2-hydroxyethyl (meth)acrylate, 4-hydroxybutyl (meth)acrylate, isobutyl (meth)acrylate, t-butyl (meth)acrylate, isooctyl (meth)acrylate, 2-methoxyethyl (meth)acrylate, methoxytriethylene glycol (meth)acrylate, 2-ethoxyethyl (meth)acrylate, 3-methoxybutyl (meth)acrylate, ethoxyethyl (meth)acrylate, butoxyethyl (meth)acrylate, ethoxydiethylene glycol (meth)acrylate, methoxydicylethyl (meth)acrylate, ethyl diglycol (meth)acrylate, cyclic trimethylolpropane formal mono(meth)acrylate, imide (meth)acrylate, isoamyl (meth)acrylate, trifluoroethyl (meth)acrylate, N-vinylformamide, cyclohexyl (meth)acrylate, benzyl (meth)acrylate, methylphenoxyethyl (meth)acrylate, 4-t-butylcyclohexyl (meth)acrylate, caprolactone-modified tetrahydrofurfuryl (meth)acrylate, tribromophenyl (meth)acrylate, ethoxylated tribromophenyl (meth)acrylate, 2-phenoxyethyl (meth)acrylate, acryloylmorpholine, phenoxydiethylene glycol (meth)acrylate, vinylcaprolactam, vinylpyrrolidone, 2-hydroxy-3-phenoxypropyl (meth)acrylate, 1,4-cyclohexanedimethanol mono(meth)acrylate, 2-(2-ethoxyethoxy)ethyl (meth)acrylate, stearyl (meth)acrylate, diethylene glycol monobutyl ether (meth)acrylate, lauryl (meth)acrylate, isodecyl (meth)acrylate, 3,3,5-trimethylcyclohexanol (meth)acrylate, isooctyl (meth)acrylate, octyl/decyl (meth)acrylate, tridecyl (meth)acrylate, caprolactone (meth)acrylate, ethoxylated (4) nonylphenol (meth)acrylate, and the like. Among these, monofunctional acrylate monomers having a phenoxyethyl acrylate structure and monofunctional acrylate monomers having an isobornyl group are preferable.

The above-described multifunctional monomers and oligomers have high viscosity. Therefore, an ink composition rich in multifunctional monomers and oligomers tends to have low fluidity and low leveling properties during applying (during printing).

Therefore, stripe patterns caused by low fluidity may occur on the surface of the cured ink composition depending on the applying conditions (printing conditions) of the ink composition. In the case of the ink composition having high leveling properties, the ink composition spreads after applying (after printing) and before being cured by light irradiation, and the boundaries between ink compositions applied (printed) at different timings become indistinct, which makes it possible to suppress the occurrence of stripe patterns.

However, in the case of the ink composition having low leveling properties, the ink composition may not spread sufficiently before being cured by light irradiation, and the boundaries between ink compositions applied (printed) at different timings may remain unresolved. In such cases, the boundary portions between the ink compositions may remain as stripe patterns in the cured ink composition.

In the present embodiment, the viscosity of the ink composition is reduced by mixing low-viscosity monofunctional monomers with multifunctional monomers and oligomers. This enhances the fluidity of the ink composition and improves the leveling properties of the ink composition during applying (during printing), so that the boundaries between ink compositions applied (printed) at different timings become indistinct before light irradiation. By doing so, the possibility of formation of stripe patterns in the cured ink composition is reduced.

The monofunctional monomer is added to adjust the viscosity to have fluidity to such an extent that allows the ink composition to spread over a predetermined area during applying of the ink composition, while stably maintaining dispersion of pigments as decorative components (powder) and coloring components in the ink composition.

It is noted that in the case of additives having functionality (decorative components) being added to the ink composition, the decorative components have larger specific gravity than pigments or the like. Therefore, in the case of the ink composition having low viscosity, the decorative components tend to settle easily. The monofunctional monomer is also added to provide the ink composition with viscosity to such an extent that can suppress sedimentation of the decorative components while ensuring fluidity of the ink composition.

The monofunctional monomer may be used by mixing a plurality of types, instead of only one type.

Furthermore, the monofunctional monomer is added to adjust the glass transition point (Tg). When the glass transition point (Tg) becomes high, the strength of the film after curing increases. Therefore, if the surface of the printed matter is covered with the ink composition and then cured, the friction resistance of the film covering the surface of the printed matter can be enhanced. Further, the monofunctional monomer has high flexibility after curing. Therefore, cracking of the film after curing can be suitably prevented.

In the present embodiment, the monofunctional monomer is contained in an amount of 20% by weight or more and less than 55% by weight relative to the total weight of the ink composition.

Table 1 below summarizes investigation results of the content ratio of the monofunctional monomer (monofunctional compound) contained in the ink composition.

TABLE 1

| | | Ink a | Ink b | Ink c |
|---|---|---|---|---|
| Multifunctional compound | | 30.0 | 30.0 | 30.0 |
| Monofunctional compound | | 39.9 | 44.9 | 49.9 |
| Additives | | 0.1 | 0.1 | 0.1 |
| Photoinitiator C | Omnirad TPO-L | 15.0 | 15.0 | 15.0 |
| Total | | 85.0 | 90.0 | 95.0 |
| Monofunctional compound | content ratio (%) | 46.9 | 49.9 | 52.5 |

| | | | |
|---|---|---|---|
| Viscosity (mPa · s) 25° C. | 223.0 | 164.0 | 98.0 |
| Tg (° C.) | 16.0 | 20.9 | 24.5 |

As is clear from Table 1 above, it was confirmed that when the content ratio of the monofunctional compound increases, the viscosity of the ink composition decreases, the glass transition point (Tg) becomes high, and the strength of the film after curing increases.

### [Photopolymerization Initiator]

The photopolymerization initiator absorbs light and releases active species (radicals). The released active species act on functional groups that serve as reaction sites of the photopolymerizable compound to initiate radical polymerization reaction of the photopolymerizable compound.

In the present embodiment, a photopolymerization initiator that can release active species (radicals) is adopted not only in the case of using a light source having peaks at a plurality of wavelengths (high pressure mercury lamp, metal halide lamp) but also in the case of using a light source having a peak at a single wavelength (UV-LED).

Here, the high pressure mercury lamp has a plurality of peaks in a wavelength range of 300 nm or more and less than 500 nm. Further, the metal halide lamp has a plurality of peaks in a wavelength range of 400 nm or more and less than 600 nm.

In contrast, UV-LEDs include those having a single wavelength peak on the lower wavelength side than 410 nm, for example, those having a single wavelength peak at 365 nm, those having a single wavelength peak at 385 nm, and those having a single wavelength peak at 405 nm.

Here, a “peak” is not limited to a single wavelength but has a certain width on the spectrum.

The inventors of the disclosure confirmed that when adopting a photopolymerization initiator having a light absorption spectrum that has most of the peak (absorption peak) on the lower wavelength side than 410 nm (wavelength region of less than 410 nm), has absorbance that decreases as it approaches 410 nm in the wavelength region of 400 nm or more, and finally has absorbance that converges to zero, the photopolymerization initiator can absorb light and generate active species (radicals) to initiate radical polymerization reaction of the photopolymerizable compound not only with light irradiated from a high pressure mercury lamp but also with light irradiated from UV-LED. Furthermore, the inventors found that yellowness after curing of the ink composition is suppressed.

In this case, the inventors found that when the addition amount of the photopolymerization initiator having most of the absorption peak on the lower wavelength side than 410 nm is increased from the usual addition amount to up to about 15 times, it is possible to exhibit the same curing characteristics (tackiness, color tone) as in the case of using a high pressure mercury lamp by increasing integrated light dose, even in the case of using a light source (UV-LED) having a peak on the lower wavelength side than 400 nm for the wavelength of irradiated light.

Furthermore, the inventors confirmed that with the photopolymerization initiator having the absorption peak on the lower wavelength side than 410 nm, even if the addition amount is increased, yellowness after curing is suppressed.

As one example, a photopolymerization initiator having a predetermined light absorption spectrum in a wavelength region of 360 nm or more and less than 410 nm in the present embodiment has been adopted.

Specifically, a photopolymerization initiator having a light absorption spectrum that has a peak in a wavelength region of less than 400 nm, has absorbance that decreases as it approaches 410 nm in a wavelength region of 400 nm or more, and has absorbance that converges to zero around 410 nm has been adopted.

### [Investigation of Photopolymerization Initiator]

The investigation results of photopolymerization initiators added to the ink composition are described below.

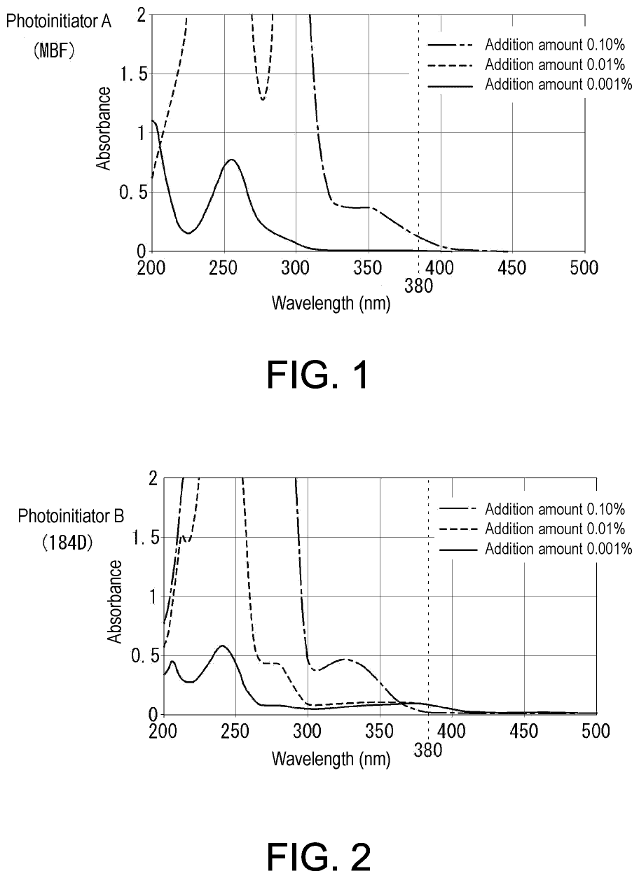

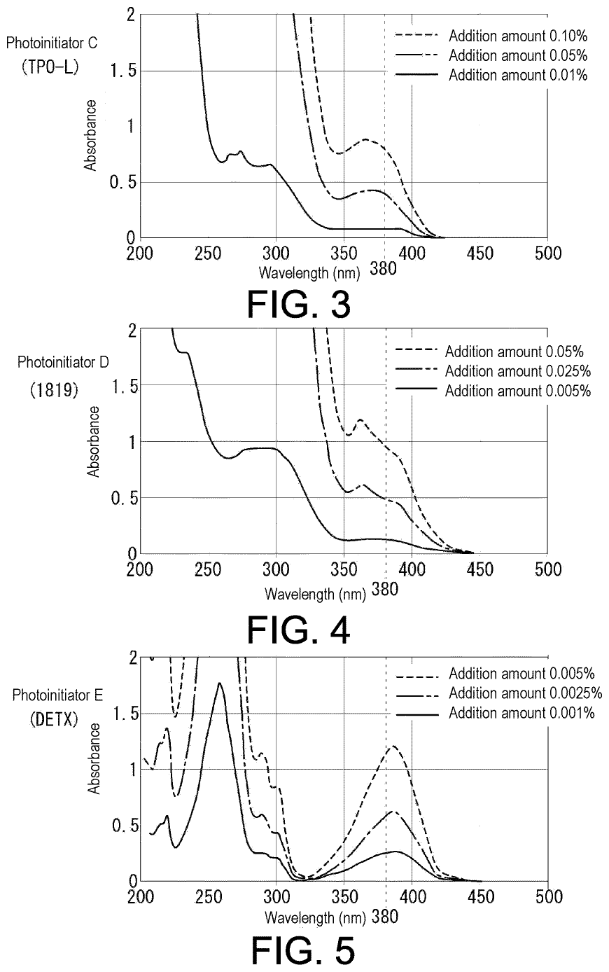

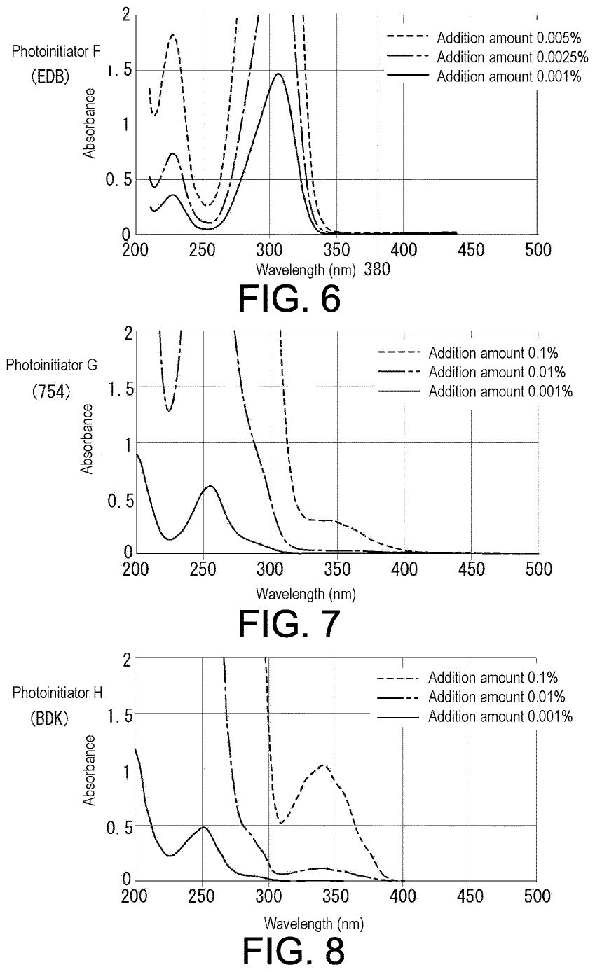

FIG. 1 is a light absorption spectrum of photopolymerization initiator A. FIG. 2 is a light absorption spectrum of photopolymerization initiator B. FIG. 3 is a light absorption spectrum of photopolymerization initiator C. FIG. 4 is a light absorption spectrum of photopolymerization initiator D. FIG. 5 is a light absorption spectrum of photopolymerization initiator E. FIG. 6 is a light absorption spectrum of photopolymerization initiator F. FIG. 7 is a light absorption spectrum of photopolymerization initiator G. FIG. 8 is a light absorption spectrum of photopolymerization initiator H.

In FIG. 1 to FIG. 8, the horizontal axis represents wavelength (nm), and the vertical axis represents absorbance.

For example, photopolymerization initiator A shown in FIG. 1 has a light absorption spectrum that has an absorption peak on the lower wavelength side than 410 nm, specifically in a wavelength region of less than 400 nm, has absorbance that decreases as it approaches 410 nm in a wavelength region of 400 nm or more, and finally has absorbance that converges to zero.

Photopolymerization initiator A has a strong absorption peak in the range of 200 nm to 320 nm and a weak absorption peak in the range of 360 nm to 410 nm. Then, in the higher wavelength region side than 380 nm, absorbance decreases as it approaches 410 nm, and finally absorbance converges to zero. It is noted that photopolymerization initiator A has a higher absorbance as the concentration increases.

This photopolymerization initiator A is exemplified by “Omnirad MBF (product name: manufactured by IGM Resins B.V.)”.

Photopolymerization initiator B shown in FIG. 2 has a light absorption spectrum that has an absorption peak on the lower wavelength side than 410 nm, specifically in a wavelength region of less than 400 nm, has absorbance that decreases as it approaches 410 nm in a wavelength region of 400 nm or more, and finally has absorbance that converges to zero. Photopolymerization initiator B has a strong absorption peak in the range of 200 nm to 300 nm, a weak absorption peak in the range of 300 nm to 360 nm, and an extremely weak absorption peak in the range of 360 nm to 410 nm.

This photopolymerization initiator B is exemplified by “Omnirad 184D (product name: manufactured by IGM Resins B.V.)”.

Photopolymerization initiator C shown in FIG. 3 has a light absorption spectrum that has an absorption peak on the lower wavelength side than 410 nm.

Photopolymerization initiator C has a strong absorption peak in the range of 200 nm to 350 nm and a moderate absorption peak in the range of 350 nm to 420 nm. Photopolymerization initiator C has absorbance that markedly decreases as it approaches 420 nm on the higher wavelength region side than 380 nm.

This photopolymerization initiator C is exemplified by “Omnirad TPO-L (product name: manufactured by IGM Resins B.V.)”.

Photopolymerization initiator D shown in FIG. 4 has a light absorption spectrum that has an absorption peak on the lower wavelength side than 430 nm.

Photopolymerization initiator D has a strong absorption peak in the range of 200 nm to 350 nm and a moderate absorption peak in the range of 350 nm to 420 nm. Photopolymerization initiator D has absorbance that markedly decreases as it approaches 430 nm on the higher wavelength region side than 400 nm.

This photopolymerization initiator D is exemplified by “JRCure 1819 (product name: manufactured by Anstar)”.

Photopolymerization initiator E shown in FIG. 5 has a light absorption spectrum that has an absorption peak on the lower wavelength side than 420 nm.

Photopolymerization initiator E has a strong absorption peak in the range of 200 nm to 320 nm and a moderate absorption peak in the range of 320 nm to 420 nm. Photopolymerization initiator E has absorbance that markedly decreases as it approaches 420 nm on the higher wavelength region side than 400 nm.

This photopolymerization initiator E is exemplified by “JRCure 1106 DETX (product name: manufactured by Anstar)”.

Photopolymerization initiator F shown in FIG. 6 has a light absorption spectrum that has an absorption peak on the lower wavelength side than 350 nm.

Photopolymerization initiator F has a moderate absorption peak in the range of 200 nm to 250 nm and a strong absorption peak in the range of 250 nm to 350 nm. Photopolymerization initiator F does not have an absorption peak in the range of 360 nm to 420 nm.

This photopolymerization initiator E is exemplified by “JRCure 1101 EDB (product name: manufactured by Anstar)”.

Photopolymerization initiator G shown in FIG. 7 has a light absorption spectrum that has an absorption peak on the lower wavelength side than 350 nm.

Photopolymerization initiator G has a strong absorption peak in the range of 200 nm to 325 nm. Photopolymerization initiator G has absorbance that markedly decreases as it approaches 420 nm on the higher wavelength region side than 375 nm.

This photopolymerization initiator G is exemplified by “Omnirad 754 (product name: manufactured by IGM Resins B.V.)”.

Photopolymerization initiator H shown in FIG. 8 has a light absorption spectrum that has an absorption peak on the lower wavelength side than 400 nm.

Photopolymerization initiator H has a strong absorption peak in the range of 200 nm to 320 nm and a moderate absorption peak in the range of 320 nm to 380 nm. Photopolymerization initiator E has absorbance that markedly decreases as it approaches 420 nm on the higher wavelength region side than 380 nm.

This photopolymerization initiator H is exemplified by “Omnirad BDK (product name: manufactured by IGM Resins B.V.)”.

Table 2 below summarizes the investigation results of photopolymerization initiators added to the ink composition.

TABLE 2

| | | STD | Ink 1 | Ink 2 | Ink 3 | Ink 4 | Ink 5 | Ink 6 | Ink 7 | Ink 8 | Ink 9 | Ink 10 | Ink 11 |
|---|---|---|---|---|---|---|---|---|---|---|---|---|---|
| Multifunctional | | 30.0 | 30.0 | 30.0 | 30.0 | 30.0 | 30.0 | 30.0 | 30.0 | 30.0 | 30.0 | 30.0 | 30.0 |
| Compound | | | | | | | | | | | | | |
| Monofunctional | | 49.9 | 49.9 | 49.9 | 49.9 | 49.9 | 49.9 | 49.9 | 49.9 | 49.9 | 49.9 | 49.9 | 49.9 |
| Compound | | | | | | | | | | | | | |
| Additives | | 0.1 | 0.1 | 0.1 | 0.1 | 0.1 | 0.1 | 0.1 | 0.1 | 0.1 | 0.1 | 0.1 | 0.1 |
| Photoinitiator A | Omnirad | 4.0 | | 5.0 | | | | | | 15.0 | 15.0 | | |
| | MBF | | | | | | | | | | | | |
| Photoinitiator B | Omnirad | 1.0 | | | 5.0 | | 5.0 | | | | | | |
| | 184D | | | | | | | | | | | | |
| Photoinitiator C | Omnirad | | 15.0 | 15.0 | 15.0 | | | | | | | | |
| | TPO-L | | | | | | | | | | | | |
| Photoinitiator D | JRCure | | | | | 15.0 | 15.0 | | | | | | |
| | 1819 | | | | | | | | | | | | |
| Photoinitiator E | JRCure | | | | | | | 15.0 | 15.0 | | | | |
| | 1106 DETX | | | | | | | | | | | | |
| Photoinitiator F | JRCure | | | | | | | | 5.0 | | | | |
| | 1101 EDB | | | | | | | | | | | | |
| Photoinitiator G | Omnirad | | | | | | | | 5.0 | | | 10.0 | |
| | 754 | | | | | | | | | | | | |
| Photoinitiator H | Omnirad | | | | | | | | 5.0 | | | | 10.0 |
| | BDK | | | | | | | | | | | | |
| Total | | 85.0 | 95.0 | 100.0 | 100.0 | 95.0 | 100.0 | 95.0 | 110.0 | 95.0 | 95.0 | 90.0 | 90.0 |
| Light source | | High | LED | LED | LED | LED | LED | LED | LED | LED | LED | LED | LED |
| | | pressure | | | | | | | | | | | |
| | | mercury | | | | | | | | | | | |
| Integrated | mJ/cm² | 3,541 | 7,470 | 7,470 | 7,470 | 7,470 | 7,470 | 2,988 | 2,988 | 6,723 | 7,470 | 3,534 | 3,534 |
| light dose | | | | | | | | | | | | | |
| Evaluation | Color tone | 3.2 | 8.1 | 5.1 | 10.2 | 4.6 | 4.9 | 13.2 | 15.2 | 3.3 | 5.7 | — | — |
| | (b*) | | | | | | | | | | | | |
| | Tackiness | 5 | 2 | 2 | 2 | 3 | 3 | 5 | 5 | 5 | 4 | 5 | 5 |

With STD in Table 2 above as a reference formulation for the ink composition, the ink compositions for evaluation (Ink 1 to Ink 11) were prepared by changing the type and addition amount of the photopolymerization initiator added.

Here, the multifunctional compound was obtained by mixing, in arbitrary proportions, CN991 (product name: manufactured by Sartomer), which is a low-viscosity aliphatic urethane acrylate oligomer, CN980 (product name: manufactured by Sartomer), which is a bifunctional aliphatic urethane acrylate oligomer, and CN989 (product name: manufactured by Sartomer), which is a trifunctional aliphatic urethane acrylate oligomer.

The monofunctional compound was obtained by mixing, in arbitrary proportions, MIRAMER M140 (product name: manufactured by Miwon Specialty Chemical Co., Ltd.), which is a monofunctional acrylate monomer having a phenoxyethyl acrylate structure, and MIRAMER M1140 (product name: manufactured by Miwon Specialty Chemical Co., Ltd.), which is a monofunctional acrylate monomer having an isobornyl group.

Then, the prepared ink compositions (Ink 1 to Ink 11) were applied to acrylic boards using a coater apparatus (OSP-100: product name) manufactured by OSG System Products Co., Ltd., and then cured by irradiating light from an LED light source until the integrated light dose reached the amounts described in Table 2 above.

It is noted that the ink composition of STD was applied to an acrylic board under the same conditions as Ink 1 to Ink 11, and then cured by irradiating light from a high pressure mercury lamp until the integrated light dose reached the amount described in Table 2 above.

Then, the values of L* (lightness), a* (red-green hue), and b* (yellow-blue hue) of the cured ink compositions (STD, Ink 1 to Ink 9) were respectively determined using a colorimeter (manufactured by Konica Minolta, Inc.: FD-7 (product name)). The above table summarizes the b* value as the indicator value representing color tone and the tackiness of the cured ink compositions.

Here, the tackiness (stickiness) in Table 2 above was evaluated on a 5-point scale from “1” to “5”.

The smaller the number, the higher the tackiness (stickiness), where “5” means “no tackiness” and “1” means “strong tackiness”.

As a result, it was confirmed that curing the ink composition (Ink 8) with LED yielded a result closest to the ink composition (STD) cured with a high pressure mercury lamp in both color tone and tackiness.

### [Addition Amount of Photopolymerization Initiator]

Table 3 below summarizes the relationship between the addition amount of photopolymerization initiator added to the ink composition, tackiness, and light source.

TABLE 3

| | | Light source | | | |
|---|---|---|---|---|---|
| | | | | High pressure mercury | |
| | | LED [irradiance | | lamp [irradiance | |
| | | (226.5 mW/cm²)] | | (651.8 mW/cm²)] | |
| | | Integrated | Integrated | Integrated | Integrated |
| | | light dose | light dose | light dose | light dose |
| | | until | until | until | until |
| | Addition | tackiness | tackiness | tackiness | tackiness |
| | amount | reached “3” | reached “5” | reached “3” | reached “5” |
| Photoinitiator | wt % | mJ/cm² | mJ/cm² | mJ/cm² | mJ/cm² |
| Omnirad | 15 | 3,096 | 5,418 | | |
| MBF | 10 | 3,870 | 5,805 | 507 | 676 |
| | 5 | 6,192 | 261,612 | | |
| Omnirad | 15 | — | — | 1,183 | — |
| TPO-L | | | | | |

In investigating the addition amount of the photopolymerization initiator added to the ink composition, (a) a plurality of ink compositions were prepared with varied addition amounts of photopolymerization initiator relative to the total weight of the ink composition. (b) Each of the prepared ink compositions was applied on an acrylic substrate with the same thickness to prepare test samples. (c) With the irradiance (mW/cm²) of the LED held constant, light was irradiated from the LED to each test sample, and the integrated light dose until the tackiness reached “5” was determined for each test sample.

A comparative test sample was prepared with an ink composition to which the photopolymerization initiator (Omnirad TPO-L) was added, and the integrated light dose until the tackiness reached “5” was determined.

In the case of using LED as the light source, it was confirmed that the ink composition can be appropriately cured by increasing the addition amount of photopolymerization initiator (Omnirad MBF) to the ink composition to at least 10% by weight. While the integrated light dose for curing an ink composition with the same addition amount of 10 wt % using a high pressure mercury lamp was 676 mJ/cm², the integrated light dose for curing using LED was 5805 mJ/cm².

The addition amount of 10% by weight for photopolymerization initiator (Omnirad MBF) relative to the ink composition is greater than the typical addition amount for photopolymerization initiator. In the case of LED, which has smaller output energy than a high pressure mercury lamp, it was confirmed that results equivalent to those obtained using a high pressure mercury lamp can be achieved by increasing the addition amount of photopolymerization initiator and increasing integrated light dose.

Typically, the photopolymerization initiator is often added in an amount of 0.1% by weight to 1.0% by weight relative to the total weight of the ink composition. In the present embodiment, assuming curing with light irradiated from UV-LED, photopolymerization initiator A is contained in an amount of 1% by weight or more and less than 15% by weight relative to the total weight of the ink composition.

Here, as the addition amount of photopolymerization initiator in the ink composition increases, there is a tendency for yellowness after curing to become stronger. Therefore, it is considered preferable for the addition amount of photopolymerization initiator to be as small as possible. However, it was confirmed that in the case of adopting an additive having a light absorption spectrum that has a peak in a wavelength region of less than 400 nm, has absorbance that decreases as it approaches 410 nm in a wavelength region of 400 nm or more, and finally has absorbance that converges to zero, even if the addition amount of the additive increases, yellowness after curing does not become stronger.

### [Investigation of Curing Conditions]

Table 4 below summarizes the investigation results of curing conditions for the ink composition in terms of the relationship between film thickness of the ink composition and integrated light dose.

TABLE 4

| | Film | Light source (LED) | | |
|---|---|---|---|---|
| | thickness | Irradiance | Irradiation | Integrated light dose |
| | μm | mW/cm² | time s | until curing mJ/cm² |
| Test | 100 | 226.5 | 20.5 | 4,644 |
| sample A | 100 | 1033 | 4.9 | 5,062 |
| | 100 | 1910 | 2.5 | 4775 |
| Test | 2-3 | 226.5 | 10.3 | 2333 |
| sample B | 2-3 | 1033 | 1.2 | 1240 |
| | 2-3 | 1910 | 0.7 | 1337 |

In investigating the curing conditions of the ink composition, (a) the ink composition was prepared with the addition amount of photopolymerization initiator unified at 10% by weight relative to the total weight of the ink composition. (b) Test sample A, in which the prepared ink composition was applied on an acrylic substrate with the same thickness (100 μm), and test sample B, in which the prepared ink composition was applied on a PET film with the same thickness (2 to 3 μm), were prepared.

Test sample A was prepared using a coater apparatus of OSP-100 (manufactured by OSG System Products Co., Ltd.). Test sample B was prepared using a bar coater #01.

With the irradiance (mW/cm²) of the LED held constant, light was irradiated from the LED to each test sample, and the integrated light dose until the tackiness reached “5” was determined for each of test samples A and B.

As a result, it was confirmed that both test sample A and test sample B can be appropriately cured, and yellowness after curing can be suppressed.

Furthermore, it was confirmed that by adjusting the irradiance of the LED light source, the ink composition can be appropriately cured within a practically acceptable irradiation time.

Hereinafter, one example of a usage mode of the ink composition will be described by taking as an example a printing system 1 that applies an ink composition to a workpiece W, which is a printing target, using the ink composition according to the embodiment.

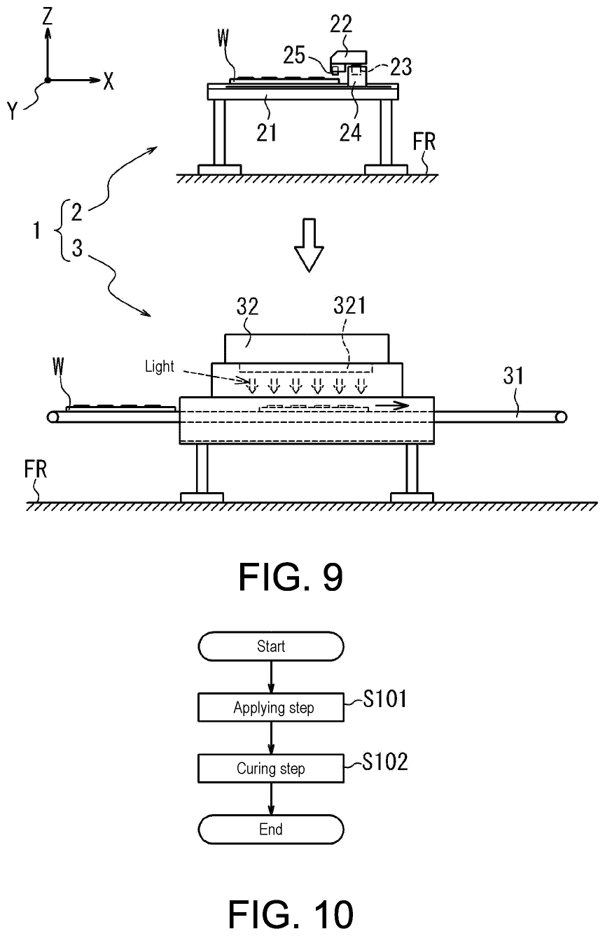

FIG. 9 is a schematic diagram illustrating the schematic configuration of the printing system 1. Reference numeral Z in FIG. 9 is a vertical line direction based on a state in which a printing apparatus 2 is grounded on a ground surface FR. Reference numeral Y is a movement direction of an applying unit 22 supported by a rail 23. Reference numeral X is a movement direction of a support unit 24 that supports the rail 23.

The printing system 1 includes the printing apparatus 2 and a light irradiation apparatus 3.

The printing apparatus 2 includes a table 21 on which the workpiece W is placed, and the applying unit 22 for the ink composition. On the table 21, the rail 23 arranged in a direction along the Y direction is supported movably in the X direction. On the rail 23, the applying unit 22 is supported movably in the Y direction.

Both ends of the rail 23 in the Y direction are supported by the support unit 24 that is provided on the table 21 to be movable in the X direction.

The applying unit 22 is an applying apparatus that sprays the ink composition onto the workpiece W by a spray method.

As described above, the decorative component contained in the ink composition often has a particle size larger than the particle size of pigments contained in conventionally known ink compositions for inkjet printing. Therefore, in the applying unit 22, a spray gun 25 is disposed to face the workpiece W on the table 21.

The printing apparatus 2 includes a drive mechanism not shown. In the printing apparatus 2, the ink composition is sprayed from the applying unit 22 onto the workpiece W while the applying unit 22 is relatively displaced in the X direction and the Y direction with respect to the workpiece W on the table 21 by the drive mechanism not shown. Thereby, the surface of the workpiece W placed on the table 21 is applied with the ink composition.

The light irradiation apparatus 3 includes a conveyor 31 for transporting the workpiece W, and a light irradiation unit 32 disposed above the conveyor 31. In the light irradiation apparatus 3, light is irradiated from a light source 321 included in the light irradiation unit 32 while the workpiece W applied with the ink composition moves from one end to the other end of the conveyor 31.

The light irradiation unit 32 employs a high pressure mercury lamp and a metal halide lamp having peaks at a plurality of wavelengths, and a UV-LED having a peak at a single wavelength, as the light source.

It is noted that in the case of employing a UV-LED as the light source, the transport speed of the conveyor 31 and the installation range of the light source 321 are set so that the integrated light dose of the medium reaches 2,000 mJ/cm² or more and less than 10,000 mJ/cm² while the medium M passes directly under the light source 321.

Hereinafter, the process from applying the ink composition on the workpiece W to curing the ink composition in the printing system 1 will be described as an applying method for applying the ink composition on the workpiece W.

FIG. 10 is a flowchart illustrating the process from applying the ink composition on the workpiece W to curing.

The applying method for ink composition includes an applying step (S101) of applying to the workpiece W the ink composition using the printing apparatus 2; and a curing step (S102) of irradiating light to the workpiece W applied with the ink composition to cure the photopolymerizable compound.

Here, in the applying step, the ink composition is applied on the workpiece W by any one of spray applying, coater applying, and inkjet applying.

As described above, the decorative component often has a particle size larger than the particle size of pigments contained in conventionally known ink compositions for inkjet printing.

In the case of the decorative component being contained in the ink composition, if the particle size of the decorative component contained in the ink composition is larger than the particle size of the pigments contained in the ink composition for inkjet printing, the ink composition may be applied on the surface of the workpiece W with the printing apparatus 2 including the spray gun 25.

Further, the ink composition may be applied on the surface of the workpiece W by a coater apparatus including a coater head (not shown) instead of the printing apparatus 2 including the spray gun 25.

Furthermore, in the curing step, light is irradiated to the workpiece W applied with the ink composition from any light source of a high pressure mercury lamp, a metal halide lamp, and a UV-LED.

In this case, in the case of irradiating light from a UV-LED, light is irradiated so that the integrated light dose of light irradiated to the workpiece applied with the ink composition becomes at least 2,000 mJ/cm² or more and less than 10,000 mJ/cm².

It is noted that an embodiment of irradiating light from at least one light source of a high pressure mercury lamp, a metal halide lamp, and a UV-LED may be adopted.

Here, in the case where the particle size of the decorative component contained in the ink composition is equal to or smaller than the particle size of the pigments contained in conventionally known ink compositions for inkjet printing and can be discharged from conventionally known inkjet heads, the ink composition may be applied on the surface of the workpiece W using an inkjet printing apparatus.

In this case, the light source may be mounted on a carriage (not shown) that carries the inkjet head, and immediately after discharge of the ink composition, light may be irradiated to the discharged ink composition to cure the ink composition. In this case, the ink composition may be cured by both the light source mounted on the carriage and the light source provided in the light irradiation apparatus 3.

The above-described embodiment illustrates one example of the photopolymerization initiator. A photopolymerization initiator having an aromatic ring may be adopted as the photopolymerization initiator. For example, benzophenone-based photopolymerization initiators, acetophenone-based photopolymerization initiators, thioxanthone-based photopolymerization initiators, and the like can be used as long as these photopolymerization initiators satisfy the above-described conditions, such as having a light absorption spectrum that has a peak in a wavelength region of less than 400 nm, and has absorbance that decreases and converges to zero in a wavelength region of 400 nm or more.

Here, the above-described ink compositions (ink 1 to ink 11) are ink compositions aimed at optimization of the photoinitiator. That is, these are clear-based inks that do not include “additives having functionality (decorative components)”.

The inventors of the disclosure prepared ink compositions using Miraval (registered trademark) and Iriodin (registered trademark) manufactured by Merck KGaA as decorative components. As a result, it was confirmed that there is room for improvement in terms of the stability over time of the prepared ink compositions when simply adding decorative components.

Specifically, it was confirmed that when leaving the prepared ink compositions, the added decorative components settled and became a so-called hard cake state that did not return to the original state even with shaking.

Therefore, the inventors prepared inks for evaluation (ink 12 to ink 15) by adding decorative components (effect pigments) manufactured by Merck KGaA and an anti-settling agent to clear base ink that does not include decorative components (functional powder).

Then, to evaluate the influence of adding the anti-settling agent, a snowman test, applying streak evaluation, and sedimentation evaluation were performed using the prepared ink compositions.

Table 5 below summarizes the evaluation results related to the anti-settling agent and anti-sagging agent added to ink compositions (inks) including decorative components (functional powder).

TABLE 5

| | | Ink 9 | Ink 12 | Ink 13 | Ink 14 | Ink 15 |
|---|---|---|---|---|---|---|
| Multifunctional Compound | | 30.0 | 30.0 | 30.0 | 30.0 | 30.0 |
| Monofunctional Compound | | 49.9 | 49.9 | 49.9 | 49.9 | 49.9 |
| Additives | | 0.1 | 0.1 | 0.1 | 0.1 | 0.1 |
| Photoinitiator A | Omnirad MBF | 15.0 | 10.0 | 10.0 | 10.0 | 10.0 |
| Additives | DISPARLON PF-920 | | 3.0 | 3.0 | | |
| (Anti-settling and | DISPARLON NS-5210A | | | | 3.0 | |
| sagging agent) | THIXOTROPE A300 | | | | | 1.0 |
| | DISPARLON 3500 | | | | | 0.5 |
| Additives | Miraval 5412 | | 5.0 | | 5.0 | 5.0 |
| (Functional powder) | Iriodin 6163 | | | 5.0 | | |
| Total | | 95.0 | 98.0 | 98.0 | 98.0 | 96.5 |
| Light source | | LED | LED | LED | — | — |
| Integrated light dose | mJ/cm² | 7,470 | 7,470 | 7,470 | — | — |
| Evaluation | Color tone (b*) | 5.7 | −3.1 | −3.1 | — | — |
| | Tackiness | 4 | 5 | 5 | — | — |
| | Snowman | | ∘ | ∘ | x | x |
| | Applying streak | | ∘ | ∘ | x | x |
| | Sedimentation test | | ∘ | — | x | — |

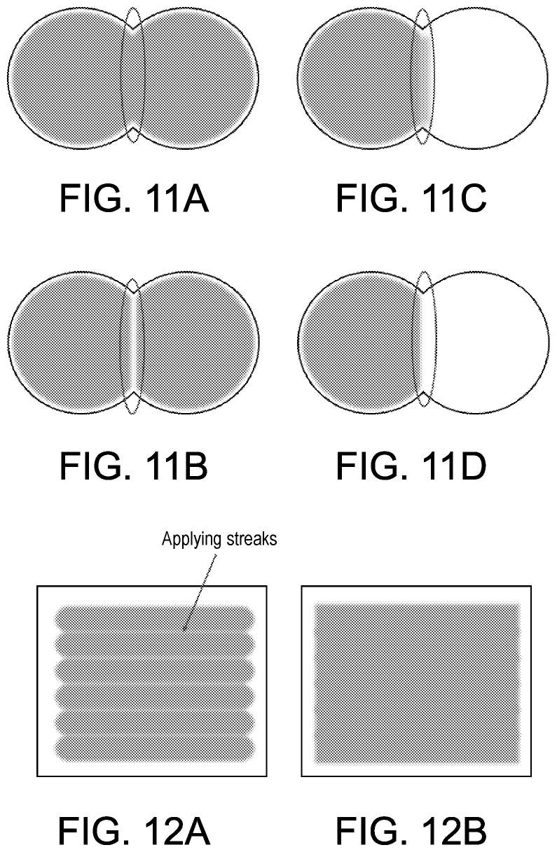

FIG. 11A to FIG. 11D are schematic diagram illustrating the snowman test.

### [Snowman Test]

The snowman test is a test conducted for the purpose of predicting the possibility of applying unevenness and streak generation in the case of spray applying inks, by observing whether there is mixing at the boundary part between inks when applying inks.

In the snowman test, a pair of ink droplets are dropped onto an acrylic plate for evaluation so as to partially overlap, and it is confirmed whether it is possible to confirm the boundary line between the dropped ink droplets at the boundary part of the pair of ink droplets. Cases where the boundary line could not be confirmed are rated as “∘”, and cases where the boundary line could be confirmed are rated as “x”.

In the embodiment, approximately 0.4 ml of ink was dropped using a pipette so that the center-to-center distance of the pair of ink droplets was approximately 1 cm, and after 3 minutes, it was confirmed whether or not a boundary line could be confirmed at the part where the pair of ink droplets contacted.

In the embodiment, confirmation was made respectively for (I) a case of forming a pair of ink droplets with evaluation ink, and (II) a case of forming a pair of ink droplets with base ink and evaluation ink.

For example, FIG. 11A shows a case where a pair of ink droplets are formed with evaluation ink and the boundary line cannot be confirmed. FIG. 11B shows a case where a pair of ink droplets are formed with evaluation ink and the boundary line can be confirmed.

FIG. 11C shows a case where a pair of ink droplets are formed with base ink and evaluation ink and the boundary line cannot be confirmed. FIG. 11D shows a case where a pair of ink droplets are formed with base ink and evaluation ink and the boundary line can be confirmed.

In the case of low ink fluidity, mixing is unlikely to occur at the boundary part between inks. Therefore, a boundary line is formed to the extent that it can be visually confirmed within the range surrounded by the ellipse in FIG. 11B and FIG. 11D. On the other hand, in the case of high ink fluidity, mixing is likely to occur at the boundary part between inks. Therefore, a boundary line cannot be visually confirmed within the range surrounded by the ellipse in FIG. 11A and FIG. 11C. In the case where one ink droplet is clear-based base ink, gradual ink mixing can be visually confirmed at the boundary part between the ink droplets.

In Table 5 above, cases where the boundary line could not be confirmed in either (I) or (II) above are rated as “∘”.

FIG. 12A and FIG. 12B are schematic diagrams illustrating the evaluation of applying streaks.

### [Evaluation of Applying Streak]

The applying streak evaluation test is a test conducted for the purpose of confirming the applying suitability of an ink by evaluating whether applying streaks occur when spray applying the ink.

In the applying streak evaluation test, an ink is loaded into an applying apparatus, spray applying is performed on an evaluation substrate under predetermined applying conditions, and whether there are applying streaks on the formed applied film surface is visually confirmed. Cases where applying streaks were not confirmed on the applied film surface are rated as “∘”, and cases where applying streaks were confirmed are rated as “x”.

In the embodiment, spray applying was performed under the following conditions using an applying apparatus DCF-605PU manufactured by MIMAKI ENGINEERING CO., LTD.
Nozzle scale: 3.10
Liquid pressure: 0.060 MPa
Atomization pressure: 0.04 MPa
Flow rate: 4.0 g/20 s
Applying width: 6.4 mm
Nozzle gap: 5.0 mm

In the embodiment, the applied film surface was observed after 5 minutes from completion of spray applying, to confirm whether applying streaks occurred which were recognized as linear light and dark areas or irregularities along the applying direction.

For example, FIG. 12A shows a case where applying streaks can be confirmed, and FIG. 12B shows a case where applying streaks cannot be confirmed.

In the case of low ink fluidity, mixing is unlikely to occur at the boundary part between inks. Therefore, a boundary line is formed to the extent that it can be visually confirmed along the movement direction of the nozzle during spray applying. On the other hand, in the case of high ink fluidity, mixing is likely to occur at the boundary part between inks. Therefore, a boundary line cannot be visually confirmed.

In Table 5 above, cases where applying streaks were not confirmed are rated as “∘”, and cases where applying streaks were confirmed are rated as “x”.

### [Sedimentation Test]

The sedimentation test is a test conducted for the purpose of confirming the storage stability of an ink in which decorative components (functional powder) are dispersed, by evaluating the sedimentation suppression and redispersibility after the ink is left standing for a certain period.

In the sedimentation test, a container is filled with the ink to be evaluated and then left standing for a certain period under predetermined temperature conditions, and (a) whether sedimentation occurs, (b) the state of the sedimentation layer, and (c) the redispersibility after re-stirring in the ink after standing are observed.

After the ink is left standing, in the case of no clear separation occurring between the supernatant and the sedimentation layer, or in the case of a uniform dispersion state being recovered in a short time by re-stirring, the storage stability is evaluated as good.

Cases where storage stability is good are rated as “∘”, and cases where storage stability is not good are rated as “x”.

In the embodiment, the inks to be evaluated (ink 12, ink 14) were filled into glass containers, and the containers were left standing for a predetermined period under multiple temperature conditions. Specifically, the containers were left standing under conditions of extremely low temperature (−20° C.), low temperature (0° C.), normal temperature (25° C.), and high temperature (60° C.).

After being left standing, the appearance of the ink under each temperature condition was observed, and (a) whether sedimentation occurs, (b) the state of the sedimentation layer, and (c) the redispersibility after re-stirring were confirmed visually.

As a result, for ink 12, even after standing at normal temperature for 7 days, almost no sedimentation was observed. Furthermore, although sedimentation occurred at high temperature (60° C.), it was confirmed that the initial dispersion state could be restored by re-stirring. That is, at high temperature (60° C.), there was mild sedimentation that allowed redispersion, and it was confirmed that hard sedimentation (so-called hard cake state) that would make redispersion difficult did not occur.

On the other hand, for ink 14, more sedimentation than in ink 12 was confirmed at normal temperature. Furthermore, at high temperature (60° C.), significant sedimentation occurred, and it was confirmed that separation occurred to a visually recognizable extent.

As a result of the above evaluations, it was confirmed that using the anti-settling agent “DISPARLON PF-920 (registered trademark)” manufactured by Kusumoto Chemicals, Ltd. as an anti-settling agent provided good results in the snowman test, applying streak evaluation, and sedimentation evaluation when preparing inks containing Miraval (registered trademark) and Iriodin (registered trademark) manufactured by Merck KGaA as decorative components, and improved the stability over time of the inks.

Here, for ink 12 and ink 13 that showed good results in the snowman test and applying streak evaluation, measurement of the b* value as the indicator value representing color tone and evaluation of the tackiness of the cured ink composition were performed. The measurement conditions and evaluation methods are the same as for ink 1 to ink 11 described above.

Although direct comparison with ink 9 was not possible due to the inclusion of decorative components (functional powder), good results were confirmed at least in tackiness.

As described above, the ink composition according to the present embodiment has the following configuration.
(1) An ink composition includes a photopolymerizable compound and a photopolymerization initiator.

The photopolymerization initiator has a predetermined light absorption spectrum in a wavelength region of 360 nm or more and less than 410 nm, and is contained in an amount of 1% by weight or more and less than 15% by weight relative to a total weight of the ink composition.

When the photopolymerization initiator having a predetermined light absorption spectrum on the lower wavelength side than 410 nm, specifically in a wavelength region of 360 nm or more and less than 410 nm, is contained in an amount of 1% by weight or more and less than 15% by weight relative to the total weight of the ink composition, yellowness of printed matter can be suppressed.
(2) The photopolymerization initiator has a light absorption spectrum that has a peak in a wavelength region of less than 400 nm, and has absorbance that decreases and converges to zero in a wavelength region of 400 nm or more.

When the photopolymerization initiator that has most of the peak in a wavelength region of less than 400 nm is used, yellowness of printed matter after curing can be suppressed. Furthermore, since the photopolymerization initiator has a light absorption spectrum in which absorbance decreases and converges to zero in a wavelength region of 400 nm or more, even with a peak in a wavelength region of less than 400 nm, light can be absorbed by increasing integrated light dose to generate active species (radicals) and initiate the photocuring reaction of the photopolymerizable compound. Therefore, yellowness after curing can be suppressed while appropriately curing the photopolymerizable compound.
(3) The photopolymerizable compound includes at least one of a multifunctional monomer and a multifunctional oligomer.

At least one of the multifunctional monomer and the multifunctional oligomer is contained in an amount of 20% by weight or more and less than 40% by weight relative to the total weight of the ink composition.

It is noted that “at least one of the multifunctional monomer and the multifunctional oligomer” mentioned here means that in the case of including both the multifunctional monomer and the multifunctional oligomer, the combined weight of the weight of the multifunctional monomer and the weight of the multifunctional oligomer is 20% by weight or more and less than 40% by weight relative to the total weight of the ink composition. Further, in the case of including only the multifunctional monomer, it means that the weight of the multifunctional monomer is 20% by weight or more and less than 40% by weight relative to the total weight of the ink composition. In the case of including only the multifunctional oligomer, it means that the weight of the multifunctional oligomer is 20% by weight or more and less than 40% by weight relative to the total weight of the ink composition.

Multifunctional monomers and oligomers have a plurality of functional groups such as acrylate groups and epoxy groups within the molecule. That is, multifunctional monomers and oligomers include a plurality of reaction sites within the molecule, and form many crosslinking points between molecules to form a strong cured film in response to light irradiation. This makes it possible to ensure the strength of the printed matter without impairing the design properties of the printed matter.
(4) The photopolymerizable compound includes a monofunctional monomer in an amount of 20% by weight or more and less than 55% by weight relative to the total weight of the ink composition.

Monofunctional monomers have low viscosity, and by mixing monofunctional monomers with multifunctional monomers and multifunctional oligomers, the viscosity of the ink composition can be adjusted. This makes it possible to enhance the fluidity of the ink composition before curing and improve leveling properties during printing. Furthermore, by adjusting the amount of monofunctional monomers, it becomes possible to accommodate discharge from various mechanisms ranging from inkjet to dispenser.

This makes adjustment possible in portions where the applied ink compositions overlap, so that the ink compositions blend together and boundaries become indistinct in the short time after printing and before light irradiation.

In the case of the ink composition having low leveling properties, stripe patterns may remain along the boundaries between ink compositions in portions where the ink compositions overlap. In this state, stripe patterns may occur in the printed matter after curing in response to light irradiation, which may affect the design properties of the printed matter.

As described above, by including monofunctional monomers, the leveling properties of the ink composition can be improved and the occurrence of stripe patterns can be suitably prevented.
(5) The photopolymerization initiator has a peak (absorption peak) at least at any one of 365 nm, 385 nm, and 405 nm, and is capable of releasing active species.

With this configuration, the ink composition including the photopolymerizable compound can be cured using a UV-LED light source that has a single peak (single wavelength). UV-LED light sources are less expensive, generate less heat, and have higher light utilization efficiency compared to high pressure mercury lamps and metal halide lamps. Therefore, the disclosure can also suitably deal with cases where an ink composition including a photopolymerizable compound is cured with a UV-LED light source (single wavelength).

UV-LED has a response speed of microseconds or less, and has less degradation due to repeated ON/OFF compared to UV lamps such as high pressure mercury lamps. Further, the service life is 10,000 hours to several tens of thousands of hours depending on usage conditions, which extends from several times to nearly 10 times the service life of ultraviolet lamps. Therefore, adopting a UV-LED light source can be expected to reduce running costs.

The disclosure can also be specified as an applying system for ink composition that applies an ink composition to a workpiece W.
(6) The applying system for ink composition includes:
an applying apparatus that applies to a workpiece an ink composition including at least a photopolymerizable compound and a photopolymerization initiator; and
a light irradiation apparatus that irradiates light to the workpiece applied with the ink composition.

The photopolymerizable compound includes at least one of a multifunctional monomer and a multifunctional oligomer, and a monofunctional monomer.

At least one of the multifunctional monomer and the multifunctional oligomer is contained in an amount of 20% by weight or more and less than 40% by weight relative to a total weight of the ink composition.

The monofunctional monomer is contained in an amount of 20% by weight or more and less than 55% by weight relative to the total weight of the ink composition.

The photopolymerization initiator has a predetermined light absorption spectrum in a wavelength region of 360 nm or more and less than 410 nm, and is contained in an amount of 1% by weight or more and less than 15% by weight relative to the total weight of the ink composition.

The light irradiation apparatus includes at least one of a high pressure mercury lamp, a metal halide lamp, and a UV-LED as a light source.

With this configuration, it is possible to provide an applying system for ink composition that can cure an ink composition including a photopolymerizable compound using a UV-LED light source having a single wavelength peak. Furthermore, yellowness of printed matter after curing the photopolymerizable compound can be suppressed.
(7) In a case where the UV-LED is used as the light source, an irradiation dose of the light is set so that an integrated light dose of light irradiated to the workpiece applied with the ink composition becomes at least 2,000 mJ/cm² or more and less than 10,000 mJ/cm².

With this configuration, by increasing the integrated light dose, the ink composition including the photopolymerizable compound can be cured using a UV-LED light source having a single wavelength peak.

The disclosure can also be specified as an applying method for ink composition that applies an ink composition to a workpiece W.
(8) The applying method for ink composition is a method for applying to a workpiece an ink composition including at least a photopolymerizable compound and a photopolymerization initiator to impart decorative properties to the workpiece.

The applying method for ink composition includes:
applying to the workpiece the ink composition; and
irradiating light to the workpiece applied with the ink composition to cure the photopolymerizable compound.

The photopolymerizable compound includes at least one of a multifunctional monomer and a multifunctional oligomer, and a monofunctional monomer.

At least one of the multifunctional monomer and the multifunctional oligomer is contained in an amount of 20% by weight or more and less than 40% by weight relative to a total weight of the ink composition.

The monofunctional monomer is contained in an amount of 20% by weight or more and less than 55% by weight relative to the total weight of the ink composition.

The photopolymerization initiator has a predetermined light absorption spectrum in a wavelength region of 360 nm or more and less than 410 nm, and is contained in an amount of 1% by weight or more and less than 15% by weight relative to the total weight of the ink composition.

The ink composition is applied on the workpiece by any one of spray applying, coater applying, and inkjet applying.

Light is irradiated to the workpiece applied with the ink composition from any light source of a high pressure mercury lamp, a metal halide lamp, and a UV-LED.

With this configuration, yellowness of the printed matter after curing the photopolymerizable compound can be suppressed.
(9) In a case of irradiating light from the UV-LED, an irradiation dose of the light is set so that an integrated light dose of light irradiated to the workpiece applied with the ink composition becomes at least 2,000 mJ/cm² to 10,000 mJ/cm².

With this configuration, by increasing the integrated light dose, the ink composition including the photopolymerizable compound can be cured using a UV-LED light source having a single wavelength peak. Furthermore, yellowness of the printed matter can be suppressed.

Although the embodiments of the disclosure have been described above, the disclosure is not limited only to the aspects shown in these embodiments. Modifications can be made as appropriate within the scope of the technical concept of the disclosure.

What is claimed is:

1. An ink composition, comprising:
a photopolymerizable compound; and
a photopolymerization initiator, wherein:
the photopolymerization initiator has a predetermined light absorption spectrum in a wavelength region of 360 nm or more and less than 410 nm, and is contained in an amount of 1% by weight or more and less than 15% by weight relative to a total weight of the ink composition.

2. The ink composition according to claim 1, wherein:
the photopolymerization initiator has a light absorption spectrum that has a peak in a wavelength region of less than 400 nm, and has absorbance that decreases and converges to zero in a wavelength region of 400 nm or more.

3. The ink composition according to claim 2, wherein:
the photopolymerizable compound comprises at least one of a multifunctional monomer and a multifunctional oligomer, and
at least one of the multifunctional monomer and the multifunctional oligomer is contained in an amount of 20% by weight or more and less than 40% by weight relative to the total weight of the ink composition.

4. The ink composition according to claim 3, wherein:
the photopolymerizable compound comprises a monofunctional monomer in an amount of 20% by weight or more and less than 55% by weight relative to the total weight of the ink composition.

5. The ink composition according to claim 1, wherein:
the photopolymerization initiator has a peak at least at any one of 365 nm, 385 nm, and 405 nm, and is capable of releasing active species.

6. The ink composition according to claim 2, wherein:
the photopolymerization initiator has a peak at least at any one of 365 nm, 385 nm, and 405 nm, and is capable of releasing active species.

7. The ink composition according to claim 3, wherein:
the photopolymerization initiator has a peak at least at any one of 365 nm, 385 nm, and 405 nm, and is capable of releasing active species.

8. The ink composition according to claim 4, wherein:
the photopolymerization initiator has a peak at least at any one of 365 nm, 385 nm, and 405 nm, and is capable of releasing active species.

9. An applying system for ink composition, comprising:
an applying apparatus that applies to a workpiece an ink composition comprising at least a photopolymerizable compound and a photopolymerization initiator; and
a light irradiation apparatus that irradiates light to the workpiece applied with the ink composition, wherein:
the photopolymerizable compound comprises at least one of a multifunctional monomer and a multifunctional oligomer, and a monofunctional monomer,
at least one of the multifunctional monomer and the multifunctional oligomer is contained in an amount of 20% by weight or more and less than 40% by weight relative to a total weight of the ink composition,
the monofunctional monomer is contained in an amount of 20% by weight or more and less than 55% by weight relative to the total weight of the ink composition,
the photopolymerization initiator has a predetermined light absorption spectrum in a wavelength region of 360 nm or more and less than 410 nm, and is contained in an amount of 1% by weight or more and less than 15% by weight relative to the total weight of the ink composition, and
the light irradiation apparatus comprises at least one of a high pressure mercury lamp, a metal halide lamp, and a UV-LED as a light source.

10. The applying system for ink composition according to claim 9, wherein:
in a case where the UV-LED is used as the light source, an irradiation dose of the light is set so that an integrated light dose of light irradiated to the workpiece applied with the ink composition becomes at least 2,000 mJ/cm² or more and less than 10,000 mJ/cm².

11. The applying system for ink composition according to claim 9, wherein:
the photopolymerization initiator has a light absorption spectrum that has a peak in a wavelength region of less than 400 nm, and has absorbance that decreases and converges to zero in a wavelength region of 400 nm or more.

12. The applying system for ink composition according to claim 9, wherein:
the photopolymerization initiator has a peak at least at any one of 365 nm, 385 nm, and 405 nm, and is capable of releasing active species.

13. The applying system for ink composition according to claim 10 wherein:
the photopolymerization initiator has a peak at least at any one of 365 nm, 385 nm, and 405 nm, and is capable of releasing active species.

14. The applying system for ink composition according to claim 11, wherein:
the photopolymerization initiator has a peak at least at any one of 365 nm, 385 nm, and 405 nm, and is capable of releasing active species.

15. An applying method for ink composition for applying to a workpiece an ink composition comprising at least a photopolymerizable compound and a photopolymerization initiator to impart decorative properties to the workpiece, the applying method for ink composition comprising:
applying to the workpiece the ink composition; and
irradiating light to the workpiece applied with the ink composition to cure the ink composition by polymerizing the photopolymerizable compound, wherein:
the photopolymerizable compound comprises at least one of a multifunctional monomer and a multifunctional oligomer, and a monofunctional monomer,
at least one of the multifunctional monomer and the multifunctional oligomer is contained in an amount of 20% by weight or more and less than 40% by weight relative to a total weight of the ink composition,
the monofunctional monomer is contained in an amount of 20% by weight or more and less than 55% by weight relative to the total weight of the ink composition,
the photopolymerization initiator has a predetermined light absorption spectrum in a wavelength region of 360 nm or more and less than 410 nm, and is contained in an amount of 1% by weight or more and less than 15% by weight relative to the total weight of the ink composition,
the ink composition is applied on the workpiece by any one of spray applying, coater applying, and inkjet applying, and
light is irradiated to the workpiece applied with the ink composition from any light source of a high pressure mercury lamp, a metal halide lamp, and a UV-LED.

16. The applying method for ink composition according to claim 15, wherein:
in a case of irradiating light from the UV-LED, an irradiation dose of the light is determined so that an integrated light dose of light irradiated to the workpiece applied with the ink composition becomes at least 2,000 mJ/cm² or more and less than 10,000 mJ/cm².

17. The applying method for ink composition according to claim 15, wherein:
the photopolymerization initiator has a light absorption spectrum that has a peak in a wavelength region of less than 400 nm, and has absorbance that decreases and converges to zero in a wavelength region of 400 nm or more.

18. The applying method for ink composition according to claim 15, wherein:
the photopolymerization initiator has a peak at least at any one of 365 nm, 385 nm, and 405 nm, and is capable of releasing active species.

19. The applying method for ink composition according to claim 16, wherein:
the photopolymerization initiator has a peak at least at any one of 365 nm, 385 nm, and 405 nm, and is capable of releasing active species.

20. The applying method for ink composition according to claim 17, wherein:
the photopolymerization initiator has a peak at least at any one of 365 nm, 385 nm, and 405 nm, and is capable of releasing active species.
